(19) United States
(12) Patent Application Publication
(10) Pub. No.: US 2025/0099945 A1
(43) Pub. Date: Mar. 27, 2025

(54) FERRITE/SILVER/ZINC INDIUM SULFIDE COMPOSITE PHOTOCATALYST

(71) Applicant: UNIVERSITY OF SHANGHAI FOR SCIENCE AND TECHNOLOGY, SHANGHAI (CN)

(72) Inventors: YING LI, SHANGHAI (CN); HUA MIN, SHANGHAI (CN); DONGSHENG JIA, SHANGHAI (CN); MITANG WANG, SHANGHAI (CN); DONGLIANG ZHANG, SHANGHAI (CN)

(73) Assignee: UNIVERSITY OF SHANGHAI FOR SCIENCE AND TECHNOLOGY, SHANGHAI (CN)

(21) Appl. No.: 18/731,307

(22) Filed: Jun. 2, 2024

(30) Foreign Application Priority Data
Sep. 21, 2023 (CN) 2023112253490

(51) Int. Cl. B01J 27/04; B01J 6/00; B01J 23/50; B01J 23/83; B01J 35/00; B01J 35/39; B01J 37/06; B01J 37/08; B01J 37/34; C02F 1/30; C02F 101/30; C02F 103/30

(52) U.S. Cl. CPC B01J 27/04; B01J 6/001; B01J 23/50; B01J 23/83; B01J 35/19; B01J 35/39; B01J 37/06; B01J 37/088; B01J 37/34; C02F 1/30; C02F 2101/308; C02F 2103/30; C02F 2305/10

(57) ABSTRACT

Preparation method of a lanthanum ferrite/silver/zinc indium sulfide composite photocatalyst. Includes following steps: dissolving citric acid, an iron-containing compound, and a lanthanum-containing compound in a first dispersant to obtain a first solution; carrying out a hydrothermal reaction on the first solution, prior to washing and drying sequentially, to obtain a first dried sample; calcining the first dried sample to obtain a lanthanum ferrite sample; adding deionized water and a silver nitrate solution in the lanthanum ferrite sample, prior to irradiation under a xenon lamp, and then washing and drying, to obtain a second dried sample; dissolving the second dried sample, zinc chloride, thioacetamide, and indium chloride in a second dispersant to obtain a second solution; and carrying out a hydrothermal reaction on the second solution, prior to washing and drying sequentially to obtain a lanthanum ferrite/silver/zinc indium sulfide composite photocatalyst, which can increase an absorption rate of visible light.

### TECHNICAL FIELD

This application relates to a photocatalyst, and in particular, to a preparation method and a use method of a lanthanum ferrite/silver/zinc indium sulfide composite photocatalyst.

### BACKGROUND

With the continuous development of society and technology, the living standard of people has improved rapidly, while a series of problems such as environmental pollution and energy depletion have also occurred. To resolve these problems, scientists have studied a number of methods for environmental remediation. The solar energy, as the main energy in space, is tremendous through radiation by the sun. Based on this, scientists discovered the photocatalytic technology. With the help of the solar energy, chemical reactions that were previously difficult to occur can be carried out in mild environments by using photocatalysts. The photocatalytic technology is not only excellent in hydrogen production from water decomposition, but also has great potential to improve the global environment in terms of pollutant degradation and carbon dioxide fixation. Therefore, the semiconductor photocatalytic technology is very important in energy and environment.

Among many photocatalysts, zinc indium sulfide is considered to be one of the photocatalysts that are expected to replace titanium dioxide due to its narrow band gap, high visible-light utilization rate, and high catalytic activity. Therefore, it is urgent to invent a photocatalyst containing zinc indium sulfide to replace titanium dioxide, so as to improve photocatalytic performance.

### SUMMARY

Embodiments of this application provide a preparation method and a use method of a lanthanum ferrite/silver/zinc indium sulfide composite photocatalyst, to improve a visible-light utilization rate of the photocatalyst.

To resolve the foregoing technical problem, this application is implemented as follows.

According to a first aspect, a preparation method of a lanthanum ferrite/silver/zinc indium sulfide composite photocatalyst is provided, including the following steps: dissolving citric acid, an iron-containing compound, and a lanthanum-containing compound in a first dispersant to obtain a first solution; carrying out a hydrothermal reaction on the first solution, prior to washing and drying sequentially, to obtain a first dried sample; calcining the first dried sample to obtain a lanthanum ferrite sample; adding deionized water and a silver nitrate solution in the lanthanum ferrite sample, prior to irradiation under a xenon lamp, and then washing and drying, to obtain a second dried sample; dissolving the second dried sample, zinc chloride, thioacetamide, and indium chloride in a second dispersant to obtain a second solution; and carrying out a hydrothermal reaction on the second solution, prior to washing and drying sequentially, to obtain a lanthanum ferrite/silver/zinc indium sulfide composite photocatalyst.

In a first possible implementation of the first aspect, in the step of dissolving the citric acid, the iron-containing compound, and the lanthanum-containing compound in the first dispersant, the iron-containing compound is ferric nitrate nonahydrate, the lanthanum-containing compound is lanthanum nitrate hexahydrate, the first dispersant is deionized water, and a molar ratio of the ferric nitrate nonahydrate to the lanthanum nitrate hexahydrate is 1:1.

In a second possible implementation of the first aspect, in the step of carrying out the hydrothermal reaction on the first solution, prior to washing and drying sequentially, a temperature for the hydrothermal reaction is 180° C., a time for the hydrothermal reaction is 12 h, a time of stirring for the hydrothermal reaction is 30 min, and a temperature for drying is 60° C.

In a third possible implementation of the first aspect, in the step of calcining the first dried sample, a temperature for calcining is 800° C., and a time for calcining is 2 h.

In a fourth possible implementation of the first aspect, in the step of adding the deionized water and the silver nitrate solution in the lanthanum ferrite sample, prior to irradiation under the xenon lamp, a molar ratio of lanthanum ferrite to silver nitrate is 2:1, the deionized water is 40 mL, power of the xenon lamp is 300 W, and a time for irradiation is 1 h. In a fifth possible implementation of the first aspect, in the step of dissolving the second dried sample, the zinc chloride, the thioacetamide, and the indium chloride in the second dispersant, a molar ratio of lanthanum ferrite/silver to the zinc chloride is 1:10, a molar ratio of the zinc chloride to the indium chloride to the thioacetamide is 1:2:4, the indium chloride is indium chloride tetrahydrate, and the second dispersant is a mixture of 95% ethanol and water in a volume ratio of 1:1.

In a sixth possible implementation of the first aspect, in the step of carrying out the hydrothermal reaction on the second solution, a temperature for the hydrothermal reaction is 160° C., and a time for the hydrothermal reaction is 2 h.

In a seventh possible implementation of the first aspect, a microstructure of the lanthanum ferrite/silver/zinc indium sulfide composite photocatalyst is a lanthanum ferrite sphere loaded with silver and zinc indium sulfide nanosheets, a diameter of the lanthanum ferrite sphere is 0.8-1.2 μm, and a diameter of the lanthanum ferrite/silver/zinc indium sulfide composite photocatalyst is 8 μm.

According to a second aspect, a use method of a lanthanum ferrite/silver/zinc indium sulfide composite photocatalyst is provided, including the following steps: preparing the lanthanum ferrite/silver/zinc indium sulfide composite photocatalyst by the preparation method according to any one of the first aspect; mixing the lanthanum ferrite/silver/zinc indium sulfide composite photocatalyst and dye wastewater, prior to stirring in the dark; and carrying out a photocatalytic reaction under light to degrade the dye wastewater.

In a first possible implementation of the second aspect, a usage amount of the lanthanum ferrite/silver/zinc indium sulfide composite photocatalyst is 0.02 g, the dye wastewater is methylene blue wastewater, a concentration of methylene blue in the methylene blue wastewater is 70 mg/L, and a time for stirring is 2.5 h.

In the embodiments of this application, a lanthanum ferrite sample is prepared from citric acid, an iron-containing compound, and a lanthanum-containing compound, then the lanthanum ferrite sample and a silver nitrate solution are subjected to a reaction to prepare lanthanum ferrite/silver, and finally zinc chloride, thioacetamide, indium chloride, and the lanthanum ferrite/silver are subjected to a reaction to prepare a lanthanum ferrite/silver/zinc indium sulfide composite photocatalyst. In the lanthanum ferrite/silver/zinc indium sulfide composite photocatalyst prepared in this application, lanthanum ferrite has a band gap of 1.9 eV and can form a p-n heterostructure with zinc indium sulfide of a band gap of 2.5 eV, so that an absorption rate of visible light can be increased. In addition, through the addition of silver, a good temporary storage environment is provided on the silver load for photoelectrons, which can reduce a recombination rate of carriers. Moreover, the composite material forms a smaller band gap, which helps full absorption of visible light. The lanthanum ferrite/silver/zinc indium sulfide composite photocatalyst has the advantages of high efficiency, good stability, and no pollution to the environment when used in degradation of dye wastewater. Because the preparation method in this application has a simple process, low costs, and no by-products generated during the preparation, the lanthanum ferrite/silver/zinc indium sulfide composite photocatalyst has a good industrial application prospect.

### BRIEF DESCRIPTION OF THE DRAWINGS

The accompanying drawings described herein are used to provide a further understanding of this application, and form part of this application. Exemplary embodiments of this application and descriptions thereof are used to explain this application, and do not constitute any inappropriate limitation to this application. In the accompanying drawings:

FIG. 1 is a flowchart of steps of a preparation method of a lanthanum ferrite/silver/zinc indium sulfide composite photocatalyst according to this application;

FIG. 2 is a SEM image of a lanthanum ferrite spherical structure according to this application;

FIG. 3 is a SEM image of a lanthanum ferrite/silver/zinc indium sulfide composite photocatalyst according to this application;

FIG. 4 is a graph of a band gap of a lanthanum ferrite/silver/zinc indium sulfide composite photocatalyst according to this application;

FIG. 5 is a flowchart of steps of a use method of a lanthanum ferrite/silver/zinc indium sulfide composite photocatalyst according to this application;

FIG. 6 is an XRD graph of lanthanum ferrite/silver/zinc indium sulfide composite photocatalysts according to Examples 1 to 3 of this application; and

FIG. 7 shows photocatalytic degradation performance according to Examples 1 to 3 and Comparative Examples 1 and 2 of this application.

### DETAILED DESCRIPTION

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

In addition, the terms “first”, “second”, and the like as used in this specification do not specifically indicate an order or a sequence, nor are they used to limit this application, but only to distinguish components or operations described in the same technical terms.

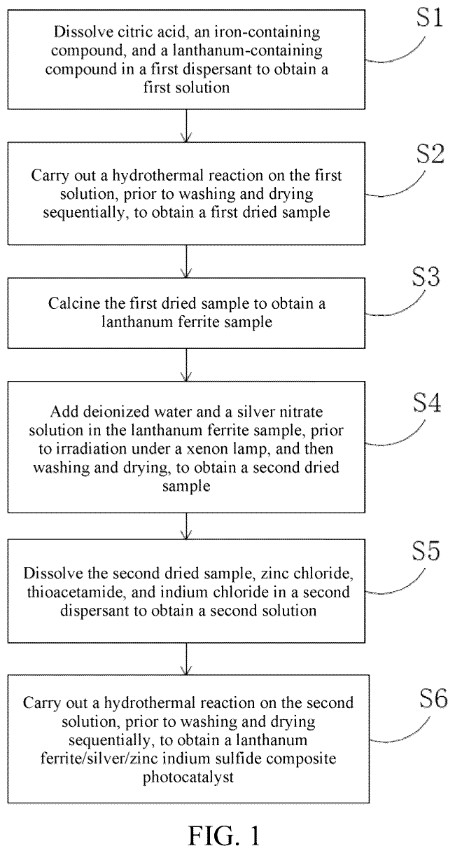

FIG. 1 is a flowchart of steps of a preparation method of a lanthanum ferrite/silver/zinc indium sulfide composite photocatalyst according to this application. As shown in the figure, the preparation method of the lanthanum ferrite/silver/zinc indium sulfide composite photocatalyst includes steps S1 to S6. When the lanthanum ferrite/silver/zinc indium sulfide composite photocatalyst is prepared by the preparation method in this embodiment, in step S1, citric acid, an iron-containing compound, and a lanthanum-containing compound are dissolved in a first dispersant to obtain a first solution. Inthis embodiment, the iron-containing compound is ferric nitrate nonahydrate, the lanthanum-containing compound is lanthanum nitrate hexahydrate, the first dispersant is deionized water, and a molar ratio of the ferric nitrate nonahydrate to the lanthanum nitrate hexahydrate is 1:1. Specifically, the ferric nitrate nonahydrate and the lanthanum nitrate hexahydrate in the molar ratio of 1:1 are added in the deionized water and stirred to disperse uniformly.

In step S2, a hydrothermal reaction is carried out on the first solution, prior to washing and drying sequentially, to obtain a first dried sample. In this embodiment, a temperature for the hydrothermal reaction is 180° C., a time for the hydrothermal reaction is 12 h, a time of stirring for the hydrothermal reaction is 30 min, and a temperature for drying is 60° C. Specifically, the first solution is poured into a hydrothermal reactor to undergo the hydrothermal reaction in the hydrothermal reactor at 180° C. for 12 h while stirring for 30 min, to obtain a precipitate. After the hydrothermal reaction is completed, the precipitate is cooled to room temperature, centrifuged, washed, and placed in a drying oven at 60° C., to obtain the first dried sample.

In step S3, the first dried sample is calcined to obtain a lanthanum ferrite sample. In this embodiment, a temperature for calcining is 800° C., and a time for calcining is 2 h. Specifically, the first dried sample obtained in step S2 is placed in a calcinator for calcining at 800° C.for 2 h, to obtain the lanthanum ferrite sample.

In step S4, deionized water and a silver nitrate solution are added in the lanthanum ferrite sample, prior to irradiation under a xenon lamp, and then washing and drying, to obtain a second dried sample. In this embodiment, a molar ratio of lanthanum ferrite to silver nitrate is 2:1, the deionized water is 40 mL, power of the xenon lamp is 300 W, and a time for irradiation is 1 h. Specifically, a specific amount of the lanthanum ferrite sample is weighed and added in a test tube, 40 mL of deionized water is added, and the silver nitrate solution is added in the molar ratio of lanthanum ferrite to silver nitrate of 2:1. Then, the test tube is irradiated under the xenon lamp of 300 W for 1 h, prior to centrifugation, washing, and drying, to obtain the second dried sample. The second dried sample is lanthanum ferrite/silver.

In step S5, the second dried sample, zinc chloride, thioacetamide, and indium chloride are dissolved in a second dispersant to obtain a second solution. In this embodiment, a molar ratio of lanthanum ferrite/silver to the zinc chloride is 1:10, a molar ratio of the zinc chloride to the indium chloride to the thioacetamide is 1:2:4, the indium chloride is indium chloride tetrahydrate, and the second dispersant is a mixture of 95% ethanol and water in a volume ratio of 1:1. Specifically, appropriate amounts of zinc chloride, thioacetamide, and indium chloride are weighed according to the foregoing requirements, and are dissolved together with the second dried sample in the second dispersant obtained by mixing 95% ethanol and water in the volume ratio of 1:1, to obtain the second solution.

In step S6, a hydrothermal reaction is carried out on the second solution, prior to washing and drying sequentially, to obtain a lanthanum ferrite/silver/zinc indium sulfide composite photocatalyst. In this embodiment, a temperature for the hydrothermal reaction is 160° C., and a time for the hydrothermal reaction is 2 h. Specifically, the second solution obtained in step S5 is stirred for 30 min and is poured into a hydrothermal reactor to undergo the hydrothermal reaction in the hydrothermal reactor at 160° C. for 2 h, to obtain a precipitate. After the hydrothermal reaction is completed, the precipitate is cooled to room temperature, centrifuged, washed, and placed in a drying oven, to obtain the lanthanum ferrite/silver/zinc indium sulfide composite photocatalyst.

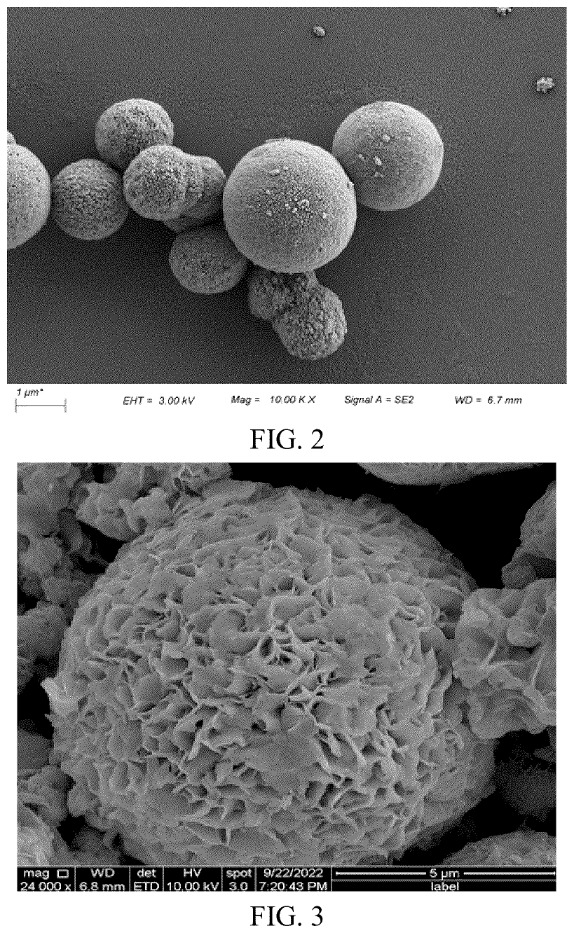

FIG. 2 is a SEM image of a lanthanum ferrite spherical structure according to this application. FIG. 3 is a SEM image of a lanthanum ferrite/silver/zinc indium sulfide composite photocatalyst according to this application. As shown in the figures, a microstructure of the lanthanum ferrite/silver/zinc indium sulfide composite photocatalyst prepared by the foregoing preparation method is a lanthanum ferrite sphere loaded with silver and zinc indium sulfide nanosheets, a diameter of the lanthanum ferrite sphere is 0.8-1.2 μm, and a diameter of the lanthanum ferrite/silver/zinc indium sulfide composite photocatalyst is 8 μm.

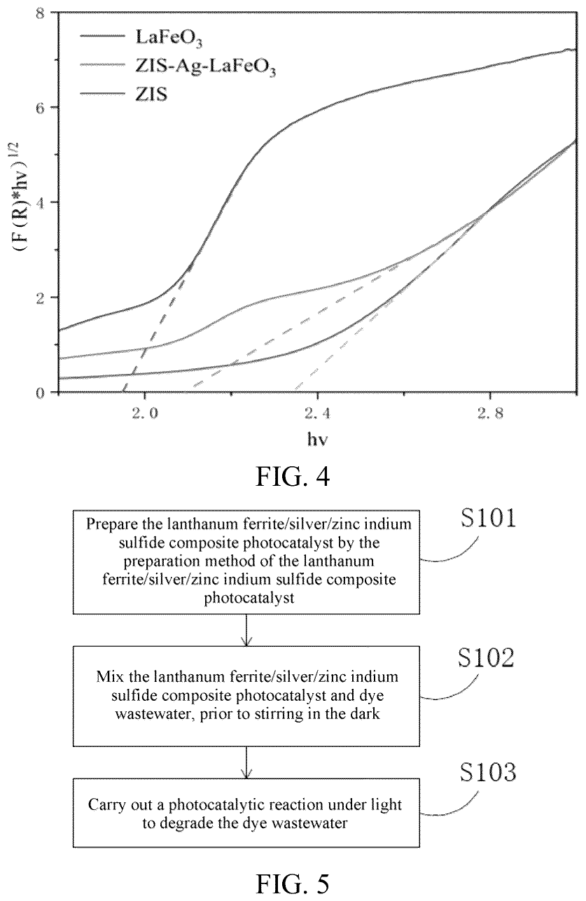

FIG. 4 is a graph of a band gap of a lanthanum ferrite/silver/zinc indium sulfide composite photocatalyst according to this application. As shown in the figure, in the lanthanum ferrite/silver/zinc indium sulfide composite photocatalyst prepared in this embodiment, lanthanum ferrite has a band gap of 1.9 eV and can form a p-n heterostructure with zinc indium sulfide of a band gap of 2.5 eV, so that an absorption rate of visible light can be increased. In addition, through the addition of silver, a good temporary storage environment is provided on the silver load for photoelectrons, which can reduce a recombination rate of carriers. Moreover, the composite material forms a smaller band gap, which helps full absorption of visible light and can efficiently degrade dye wastewater. In addition, the preparation method of the lanthanum ferrite/silver/zinc indium sulfide composite photocatalyst in this embodiment has a simple process, low costs, and no by-products generated during the preparation.

FIG. 5 is a flowchart of steps of a use method of a lanthanum ferrite/silver/zinc indium sulfide composite photocatalyst according to this application. As shown in the figure, the use method of the lanthanum ferrite/silver/zinc indium sulfide composite photocatalyst in this embodiment is mainly applicable to degradation of dye wastewater, and the use method in this embodiment includes steps S101 to S103. When the dye wastewater is degraded by the used method of the lanthanum ferrite/silver/zinc indium sulfide composite photocatalyst in this embodiment, in step S101, the lanthanum ferrite/silver/zinc indium sulfide composite photocatalyst is prepared by the preparation method of the lanthanum ferrite/silver/zinc indium sulfide composite photocatalyst described above. Then, in step S102, the lanthanum ferrite/silver/zinc indium sulfide composite photocatalyst and the dye wastewater are mixed and stirred in the dark, to reach adsorption equilibrium. In this embodiment, a usage amount of the lanthanum ferrite/silver/zinc indium sulfide composite photocatalyst is 0.02 g, the dye wastewater is methylene blue wastewater, a concentration of methylene blue in the methylene blue wastewater is 70 mg/L, and a time for stirring is 2.5 h.

Finally, in step S103, a photocatalytic reaction is carried out under light to degrade the dye wastewater. In this embodiment, the photocatalytic reaction is carried out under irradiation of a xenon lamp of 300 W for 2 h. In this case, the lanthanum ferrite/silver/zinc indium sulfide composite photocatalyst and the dye wastewater are first stirred in the dark to reach adsorption equilibrium, and then undergo the photocatalytic reaction to degrade the dye wastewater. This method has the advantages of high efficiency, good stability, and no pollution to the environment, so the lanthanum ferrite/silver/zinc indium sulfide composite photocatalyst has a good industrial application prospect.

The following further describes beneficial effects of the preparation method and the use method of the lanthanum ferrite/silver/zinc indium sulfide composite photocatalyst in this application with reference to specific examples and comparative examples.

### Example 1

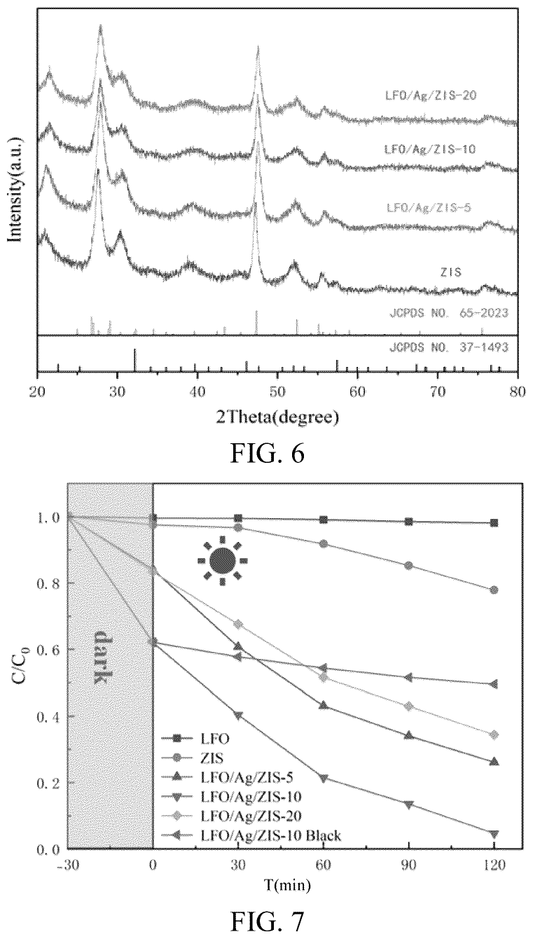

In this example, a molar ratio of lanthanum ferrite/silver/zinc indium sulfide is 2:1:5. The preparation of a lanthanum ferrite/silver/zinc indium sulfide composite photocatalyst includes the following steps:
Step 1: 0.404 g of ferric nitrate nonahydrate, 0.433 g of lanthanum nitrate hexahydrate, and 0.3842 g of citric acid were dissolved in 60 mL of deionized water and stirred for 30 min, to obtain a first solution.
Step 2: The first solution was poured into a hydrothermal reactor to undergo a hydrothermal reaction at 180° C. for 12 h, to obtain a precipitate. The precipitate was cooled to room temperature, centrifuged, washed, and dried, to obtain a first dried sample.
Step 3: The first dried sample was calcined at 800° C. for 2 h to obtain a lanthanum ferrite sample.
Step 4: 0.0485 g of lanthanum ferrite sample was weighed and dissolved in 40 mL of deionized water with 2 mL of 0.05 mol/L silver nitrate solution, and irradiated under a xenon lamp of 300 W for 1 h, prior to centrifugation, washing, and drying, to obtain a second dried sample (lanthanum ferrite/silver).
Step 5: 0.1306 g of zinc chloride, 0.5860 g of indium chloride tetrahydrate, and 0.3005 g of thioacetamide were weighed and dissolved in a mixed solution of 30 mL of deionized water and 30 mL of ethanol to obtain a second solution.
Step 6: The second solution was stirred for 30 min and then poured into a hydrothermal reactor to undergo a hydrothermal reaction at 160° C. for 2 h, to obtain a precipitate. The precipitate was cooled to room temperature, centrifuged, washed, and dried, to obtain a composite photocatalyst with a molar ratio of lanthanum ferrite to silver to zinc indium sulfide of 2:1:10, named LFO/Ag/ZIS-5, with its XRD graph shown in FIG. 6.

Degradation efficiency of the LFO/Ag/ZIS-5 prepared above in methylene blue wastewater is determined in the following steps:
Step 1: 0.02 g of LFO/Ag/ZIS-5 was weighed and added in 35 mL of 70 mg/L methylene blue dye wastewater to undergo a dark reaction in the dark for 30 min to reach adsorption equilibrium, and irradiated under a xenon lamp for 2 h.
Step 2: Determination of degradation efficiency: 5 mL of photocatalytic degradation solution was sucked from a reaction vessel with a syringe every 30 min and filtered with a filter head. Absorbance was measured by using an ultraviolet-visible spectrophotometer. Finally, the degradation efficiency was calculated. The photocatalytic degradation performance of LFO/Ag/ZIS-5 is shown in FIG. 7. After 2 h of photocatalytic reaction, the degradation efficiency of LFO/Ag/ZIS-5 on methylene blue is 73.87%.

### Example 2

A difference between this example and Example 1 lies in that a molar ratio of lanthanum ferrite/silver/zinc indium sulfide is 2:1:20 in this example. A lanthanum ferrite/silver/zinc indium sulfide composite photocatalyst prepared in this example is named LFO/Ag/ZIS-10, with its XRD graph shown in FIG. 6. Other preparation steps of the lanthanum ferrite/silver/zinc indium sulfide composite photocatalyst are the same as those in Example 1, and details are not described herein again.

A difference between determination of degradation efficiency of the LFO/Ag/ZIS-10 prepared above in methylene blue wastewater and determination of degradation efficiency of the LFO/Ag/ZIS-5 in Example 1 in methylene blue wastewater lies in that 0.02 g of LFO/Ag/ZIS-10 is weighed in this example. Other determination steps are the same as those in Example 1, and details are not described herein again. As shown in FIG. 7, after 2 h of photocatalytic reaction, the degradation efficiency of LFO/Ag/ZIS-10 on methylene blue is 95.28%.

### Example 3

A difference between this example and Example 1 lies in that a molar ratio of lanthanum ferrite/silver/zinc indium sulfide is 2:1:40 in this example. A lanthanum ferrite/silver/zinc indium sulfide composite photocatalyst prepared in this example is named LFO/Ag/ZIS-20, with its XRD graph shown in FIG. 6. Other preparation steps of the lanthanum ferrite/silver/zinc indium sulfide composite photocatalyst are the same as those in Example 1, and details are not described herein again.

A difference between determination of degradation efficiency of the LFO/Ag/ZIS-20 prepared above in methylene blue wastewater and determination of degradation efficiency of the LFO/Ag/ZIS-5 in Example 1 in methylene blue wastewater lies in that 0.02 g of LFO/Ag/ZIS-20 is weighed in this example. Other determination steps are the same as those in Example 1, and details are not described herein again. As shown in FIG. 7, after 2 h of photocatalytic reaction, the degradation efficiency of LFO/Ag/ZIS-20 on methylene blue is 65.51%.

### Comparative Example 1

Step 1: 0.404 g of ferric nitrate nonahydrate, 0.433 g of lanthanum nitrate hexahydrate, and 0.3842 g of citric acid were dissolved in 60 mL of deionized water and stirred for 30 min, to obtain a first solution.

Step 2: The first solution was poured into a hydrothermal reactor to undergo a hydrothermal reaction at 180° C. for 12 h, to obtain a precipitate.

Step 3: The precipitate was cooled to room temperature, centrifuged, washed, dried, and calcined, to obtain lanthanum ferrite (LFO).

A difference between determination of degradation efficiency of the lanthanum ferrite prepared above in methylene blue wastewater and determination of degradation efficiency of the LFO/Ag/ZIS-5 in Example 1 in methylene blue wastewater lies in that 0.02 g of lanthanum ferrite is weighed in this example. Other determination steps are the same as those in Example 1, and details are not described herein again. As shown in FIG. 7, after 2 h of photocatalytic reaction, the degradation efficiency of lanthanum ferrite on methylene blue is 1.91%.

### Comparative Example 2

Step 1: 0.1306 g of zinc chloride, 0.5860 g of indium chloride tetrahydrate, and 0.3005 g of thioacetamide were weighed and dissolved in a mixed solution of 30 mL of deionized water and 30 mL of ethanol, and stirred for 30 min, to obtain a first solution.

Step 2: The first solution was poured into a hydrothermal reactor to undergo a hydrothermal reaction at 160° C. for 2 h, to obtain a precipitate.

Step 3: The precipitate was cooled to room temperature, centrifuged, washed, and dried, to obtain zinc indium sulfide (ZIS).

A difference between determination of degradation efficiency of the zinc indium sulfide prepared above in methylene blue wastewater and determination of degradation efficiency of the LFO/Ag/ZIS-5 in Example 1 in methylene blue wastewater lies in that 0.02 g of zinc indium sulfide is weighed in this example. Other determination steps are the same as those in Example 1, and details are not described herein again. As shown in FIG. 7, after 2 h of photocatalytic reaction, the degradation efficiency of zinc indium sulfide on methylene blue is 22.08%.

With reference to the determination results in Examples 1 to 3 and Comparative Examples 1 and 2, the lanthanum ferrite/silver/zinc indium sulfide composite photocatalyst (LFO/Ag/ZIS-10) prepared in Example 2 has the highest degradation efficiency 95.28% on methylene blue after 2 h of photocatalytic reaction. Compared with the pure lanthanum ferrite prepared in Comparative Example 1 and the pure zinc indium sulfide prepared in Comparative Example 2, the lanthanum ferrite/silver/zinc indium sulfide composite photocatalyst prepared in this example reduces a recombination rate of carriers. In terms of the utilization of light energy, the composite material has a smaller band gap than the pure zinc indium sulfide, which has a higher utilization rate of light energy.

Based on the above, this application provides a preparation method and a use method of a lanthanum ferrite/silver/zinc indium sulfide composite photocatalyst. In this application, a lanthanum ferrite sample is prepared from citric acid, an iron-containing compound, and a lanthanum-containing compound, then the lanthanum ferrite sample and a silver nitrate solution are subjected to a reaction to prepare lanthanum ferrite/silver, and finally zinc chloride, thioacetamide, indium chloride, and the lanthanum ferrite/silver are subjected to a reaction to prepare a lanthanum ferrite/silver/zinc indium sulfide composite photocatalyst. In the lanthanum ferrite/silver/zinc indium sulfide composite photocatalyst prepared in this application, lanthanum ferrite has a band gap of 1.9 eV and can form a p-n heterostructure with zinc indium sulfide of a band gap of 2.5 eV, so that an absorption rate of visible light can be increased. In addition, through the addition of silver, a good temporary storage environment is provided on the silver load for photoelectrons, which can reduce a recombination rate of carriers. Moreover, the composite material forms a smaller band gap, which helps full absorption of visible light. The lanthanum ferrite/silver/zinc indium sulfide composite photocatalyst has the advantages of high efficiency, good stability, and no pollution to the environment when used in degradation of dye wastewater. Because the preparation method in this application has a simple process, low costs, and no by-products generated during the preparation, the lanthanum ferrite/silver/zinc indium sulfide composite photocatalyst has a good industrial application prospect.

It is to be noted that, in this specification, the term “include”, “comprise”, or their any other variant is intended to cover a non-exclusive inclusion, so that a process, a method, an object, or a device that includes a series of elements not only includes such elements, but also includes other elements not expressly listed, or further includes elements inherent to such a process, method, object, or device. If no more limitations are made, an element limited by “include a/an . . . ” does not exclude other same elements existing in the process, the method, the object, or the device which includes the element.

The embodiments of this application are described above with reference to the accompanying drawings, but this application is not limited to the foregoing specific implementations. The foregoing specific implementations are merely examples rather than limitations. Under the inspiration of this application, a person of ordinary skill in the art may also make many forms without departing from the purpose of this application and the protection scope of the claims, which are all within the protection scope of this application.

What is claimed is:

1. A preparation method of a lanthanum ferrite/silver/zinc indium sulfide composite photocatalyst, comprising the following steps:
dissolving citric acid, an iron-containing compound, and a lanthanum-containing compound in a first dispersant to obtain a first solution;
carrying out a hydrothermal reaction on the first solution, prior to washing and drying sequentially, to obtain a first dried sample;
calcining the first dried sample to obtain a lanthanum ferrite sample;
adding deionized water and a silver nitrate solution in the lanthanum ferrite sample, prior to irradiation under a xenon lamp, and then washing and drying, to obtain a second dried sample;
dissolving the second dried sample, zinc chloride, thioacetamide, and indium chloride in a second dispersant to obtain a second solution; and
carrying out a hydrothermal reaction on the second solution, prior to washing and drying sequentially, to obtain a lanthanum ferrite/silver/zinc indium sulfide composite photocatalyst.

2. The preparation method according to claim 1, wherein in the step of dissolving the citric acid, the iron-containing compound, and the lanthanum-containing compound in the first dispersant, the iron-containing compound is ferric nitrate nonahydrate, the lanthanum-containing compound is lanthanum nitrate hexahydrate, the first dispersant is deionized water, and a molar ratio of the ferric nitrate nonahydrate to the lanthanum nitrate hexahydrate is 1:1.

3. The preparation method according to claim 1, wherein in the step of carrying out the hydrothermal reaction on the first solution, prior to washing and drying sequentially, a temperature for the hydrothermal reaction is 180° C., a time for the hydrothermal reaction is 12 h, a time of stirring for the hydrothermal reaction is 30 min, and a temperature for drying is 60° C.

4.l The preparation method according to claim 1, wherein in the step of calcining the first dried sample, a temperature for calcining is 800° C., and a time for calcining is 2 h.

5. The preparation method according to claim 1, wherein in the step of adding the deionized water and the silver nitrate solution in the lanthanum ferrite sample, prior to irradiation under the xenon lamp, a molar ratio of lanthanum ferrite to silver nitrate is 2:1, the deionized water is 40 mL, power of the xenon lamp is 300 W, and a time for irradiation is 1 h.

6. The preparation method according to claim 1, wherein in the step of dissolving the second dried sample, the zinc chloride, the thioacetamide, and the indium chloride in the second dispersant, a molar ratio of lanthanum ferrite/silver to the zinc chloride is 1:10, a molar ratio of the zinc chloride to the indium chloride to the thioacetamide is 1:2:4, the indium chloride is indium chloride tetrahydrate, and the second dispersant is a mixture of 95% ethanol and water in a volume ratio of 1:1.

7. The preparation method according to claim 1, wherein in the step of carrying out the hydrothermal reaction on the second solution, a temperature for the hydrothermal reaction is 160° C., and a time for the hydrothermal reaction is 2 h.

8. The preparation method according to claim 1, wherein a microstructure of the lanthanum ferrite/silver/zinc indium sulfide composite photocatalyst is a lanthanum ferrite sphere loaded with silver and zinc indium sulfide nanosheets, a diameter of the lanthanum ferrite sphere is 0.8-1.2 μm, and a diameter of the lanthanum ferrite/silver/zinc indium sulfide composite photocatalyst is 8 μm.

9. A use method of a lanthanum ferrite/silver/zinc indium sulfide composite photocatalyst, comprising the following steps:
preparing the lanthanum ferrite/silver/zinc indium sulfide composite photocatalyst by the preparation method according to claims 1;
mixing the lanthanum ferrite/silver/zinc indium sulfide composite photocatalyst and dye wastewater, prior to stirring in the dark; and
carrying out a photocatalytic reaction under light to degrade the dye wastewater.

10. The use method according to claim 8, wherein a usage amount of the lanthanum ferrite/silver/zinc indium sulfide composite photocatalyst is 0.02 g, the dye wastewater is methylene blue wastewater, a concentration of methylene blue in the methylene blue wastewater is 70 mg/L, and a time for stirring is 2.5 h.
